(19) United States
(12) Patent Application Publication
(10) Pub. No.: US 2004/0150738 A1
(43) Pub. Date: Aug. 5, 2004

(54) Photographing apparatus which conducts displaying-at-long-time-exposure

(75) Inventors: Masahiko Sakimoto, Sakai-Shi (JP); Yoshio Morikawa, Okazaki-Shi (JP); Satoshi Yokota, Toyonaka-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/423,996

(22) Filed: Apr. 25, 2003

(30) Foreign Application Priority Data
Jan. 30, 2003 (JP) 2003-022131

(51) Int. Cl. H04N 5/222

(52) U.S. Cl. 348/333.11

(57) ABSTRACT

In a camera conducting a pre-photographing and a main-photographing for conducting a displaying-at-long-time-exposure, the displaying-at-long-time-exposure is continued still after main-photographing starts. Since the displaying a pre-taken image and the renewing the predicted images thereafter start from the time point, at which a release button is full-pressed, a user can confirm the predicted images in almost real time during the long-time-exposure is conducted.

This application is based on application No. 2003-22131 filed in Japan, the contents of which are hereby incorporated by reference.

### BACKGROUND OF THE INVENTION

1. Field of the Invention

The present invention relates to a photographing apparatus having a display. The photographing apparatus described here is not limited to specific one, as far as it includes a photographing function and a display. For example, the term “photographing apparatus” includes a silver halide camera (a camera using a silver halide film), a digital camera, a computer having a photographing portion, a portable telephone having a photographing function, and so on.

2. Description of the Related Art

There has been known a silver halide camera wherein a photographing device such as CCD (charge coupled device) is also provided such that, during a long-time-exposure photographing, the final image of an object after the photographing can be predicted. That is, an image data taken by the CCD is processed and a predicted image after the photographing is shown on a display. This is disclosed in Japanese unexamined patent publication No. 6-121222 (particularly, paragraphs 0083 to 0113, and FIGS. 10 and 11).

However, in the publication No. 6-121222, the predicted image is taken and renewed only before an actual long-time-exposure (namely, only during a release button is being half-pressed). Accordingly, after the release button is full-pressed to start the actual long-time-exposure, the predicted image would not be shown. Otherwise, even if the predicted image is shown, it would be what was shown in the final stage during the release button was being half-pressed. As a result, the prediction of the final image after the long-time-exposure would have low accuracy, and a user can not recognize the progress of the long-time-exposure during photographing.

### SUMMERY OF THE INVENTION

Therefore, it is an object of the present invention to provide a photographing apparatus and a method for displaying predicted images on a display, wherein the predicted images can be displayed in almost real time during the long-time-exposure, when an exposure time longer than a predetermined length is set at the photographing, or when bulb-exposure mode is selected.

In order to achieve the objects of the present invention, according to the first aspect of the present invention, there is provided a photographing apparatus, comprising: a photographing part; a display, on which images taken by the photographing part is displayed; a judgement section, which judges a photographing mode selected by a user; a setting section, which sets conditions at displaying-at-long-time-exposure, when the photographing mode judged by the judgement section conducts long-time-exposure photographing; an instruction member, which instructs the photographing apparatus to start photographing; a pre-photographing section, which conducts pre-photographing to take a pre-taken image according to an instruction from the instruction member, and which displays the pre-taken image on the display; a main-photographing section, which conducts main-photographing under the photographing mode judged by the judgement section, after the pre-photographing; and a display-renewal section, which subjects the pre-taken image to a predetermined processing at a predetermined time interval, and which renews the pre-taken image on the display, during the main-photographing, based on the conditions at the displaying-at-long-time-exposure set by the setting section.

The second aspect of the present invention provides a method for displaying predicted images on a display during long-time-exposure photographing, comprising steps of: judging a photographing mode selected by a user; setting conditions at displaying-at-long-time-exposure, when the photographing mode, which was judged, conducts the long-time-exposure photographing; conducting pre-photographing to take a pre-taken image according to an instruction from an instruction member; displaying the pre-taken image on the display; conducting main-photographing under the photographing mode which was judged, after the pre-photographing; processing the pre-taken image in a predetermined manner; and renewing the pre-taken image on the display, during the main-photographing, based on the conditions at the displaying-at-long-time-exposure which was set.

The third aspect of the present invention provides a photographing apparatus, comprising: a photographing part, which conducts pre-photographing and main-photographing, and a display, on which a pre-taken image obtained by the pre-photographing is displayed, and the pre-taken image is renewed after being processed in a predetermined manner during the main-photographing.

According to the photographing apparatuses or the method provided by the present invention, the following advantages can be brought, that is: starting from the time point, at which an photographing instruction is issued (for example, a release button is full-pressed), displaying a pre-taken image and renewing the predicted images thereafter start. Thanks to this, during the long-time-exposure is conducted, user can confirm the predicted images in almost real time. Thus, the predicted images can have high accuracy. Particularly when the bulb-exposure mode is selected, the effective criterion can be provided, with which the user can judge whether he continues the bulb-exposure, or stops it.

In the present invention, the word “displaying-at-long-time-exposure” means a displaying, wherein “starting from displaying a pre-taken image, preparing renewed images every after the predetermined renewal-interval has been passed, and such the renewed images is displayed as predicted images”. Further, the word “long-time-exposure photographing” means a photographing, wherein bulb-exposure is conducted, or a shutter speed longer than a predetermined length (for example, 4 seconds) is set by the user in shutter-speed-priority mode.

### BRIEF DESCRIPTION OF THE DRAWINGS

These and other objects and features of the present invention will become apparent from the following description taken in conjunction with the preferred embodiments thereof with reference to the accompanying drawings.

FIG. 1 is a plan view of a digital camera according to an embodiment of the present invention.

FIG. 2 is a rear view of the digital camera in FIG. 1.

FIG. 3 is an explanatory view of a function dial, which is provided on the digital camera in FIG. 1.

FIGS. 4 and 5 show a displaying on LCD, when the “S-mode” is selected in the digital camera in FIG. 1.

FIG. 6 shows a displaying on LCD, when the “M-mode” is selected in the digital camera in FIG. 1.

FIG. 7 is a block diagram showing the internal construction of the digital camera in FIG. 1.

FIGS. 8 and 9 show a flowchart explaining procedures for conducting the displaying-at-long-time-exposure.

FIG. 10 shows an another flowchart explaining another procedures for conducting the displaying-at-long-time-exposure.

FIG. 11 shows a displaying on LCD, when the “basic-sheet” is selected in the digital camera in FIG. 1.

FIG. 12 shows a displaying on LCD, when the exposure mode is “P-mode” in the digital camera in FIG. 1.

FIG. 13 shows a displaying on LCD, when the exposure mode is “B-mode” in the digital camera in FIG. 1.

FIG. 14 is an explanatory view showing the window for setting the detailed matters at the “B-mode”.

FIG. 15 shows a displaying on LCD, when the exposure mode is “S-mode” in the digital camera in FIG. 1.

FIG. 16 is an explanatory view showing the window for setting the detailed matters at the “S-mode”.

FIG. 17 is an explanatory view showing a predicted image after 5 seconds, during the displaying-at-long-time-exposure of the present invention.

FIG. 18 is an explanatory view showing a predicted image after 10 seconds, during the displaying-at-long-time-exposure of the present invention.

FIG. 19 is an explanatory view showing a predicted image after 15 seconds, during the displaying-at-long-time-exposure of the present invention.

FIG. 20 is a block diagram, wherein the present invention is applied to a silver halide camera.

FIG. 21 shows a graph representing the relationship between the exposure time and the amount of exposure.

### DETAILED DESCRIPTION OF THE PREFERRED EMBODIMENTS

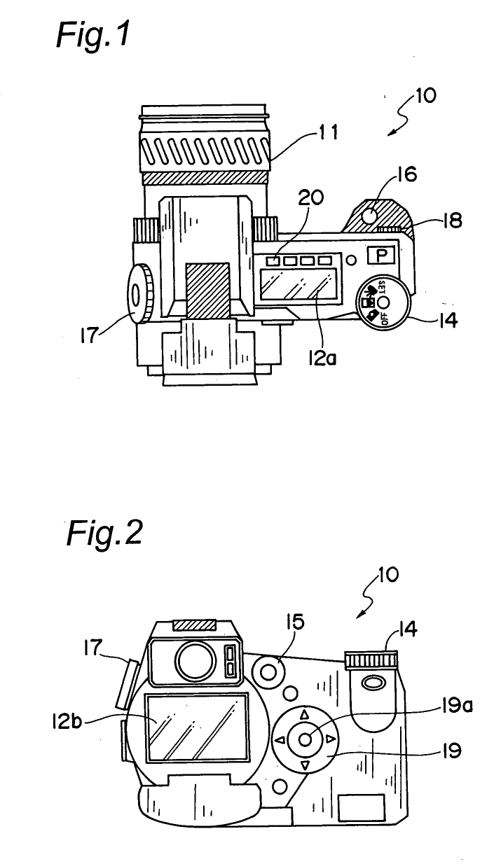

### THE GENERAL CONSTRUCTION OF CAMERA (FIGS. 1 to 3)

FIG. 1 shows a plan view of a camera 10 according to an embodiment of the present invention, and FIG. 2 shows a rear elevation of the camera 10. The camera 10 has a zoom lens barrel 11 on its front face, and liquid crystal displays (LCD) 12a and 12b on its upper and rear surfaces.

A dial 14 serves as a main switch, and also performs a mode select function. In the camera 10, 4 kinds of operating mode can be selected, that is “photographing-mode”, “play-mode”, “motion-picture-mode”, and “setting-mode”. When the dial 14 is manipulated to select the “photographing-mode”, a still picture can be taken. When a monitor selection dial 15 is manipulated to select a LCD during the “photographing-mode”, the LCD 12b on the rear surface of the camera 10 displays a live view.

When a release button 16 is half-pressed, photometry and focusing are conducted and values for control are determined. When the release button 16 is full-pressed, an exposure is conducted, based on the values for control.

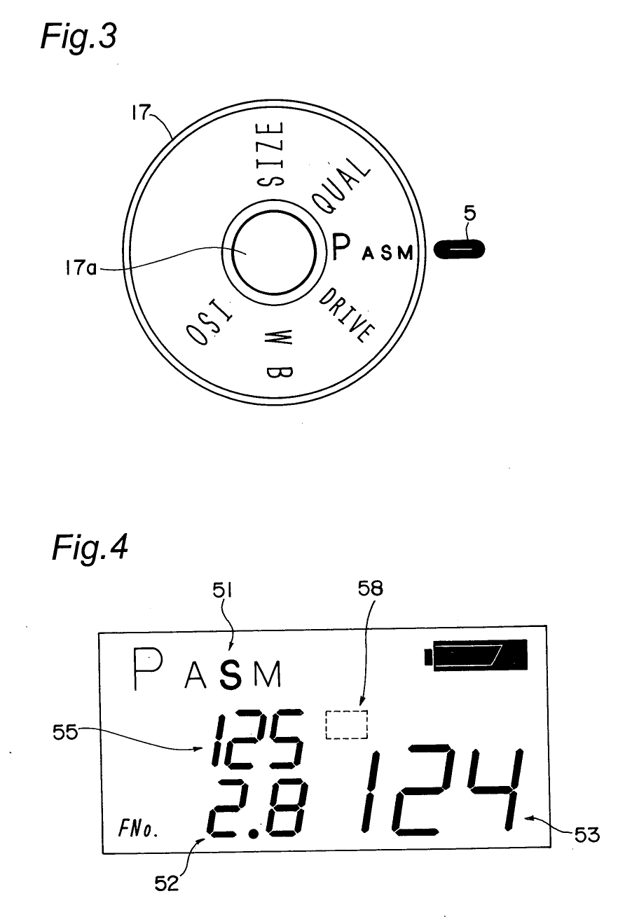

During the photographing-mode is being selected, some kinds of exposure modes can be selected by manipulating a function dial 17 and a dial 18. In detail, as shown in FIG. 3, an indication “P_{ASM}” on the dial 17 is set to a pointer 5 provided on a camera surface. Then, with a button 17a located at the center of the dial 17 being pressed, the dial 18 is rotated, so that one exposure mode can be selected among 4 kinds of exposure modes, that is, “P-mode” (program mode), “A-mode” (aperture-priority mode), “S-mode” (shutter-speed-priority mode), and “M-mode” (manual mode).

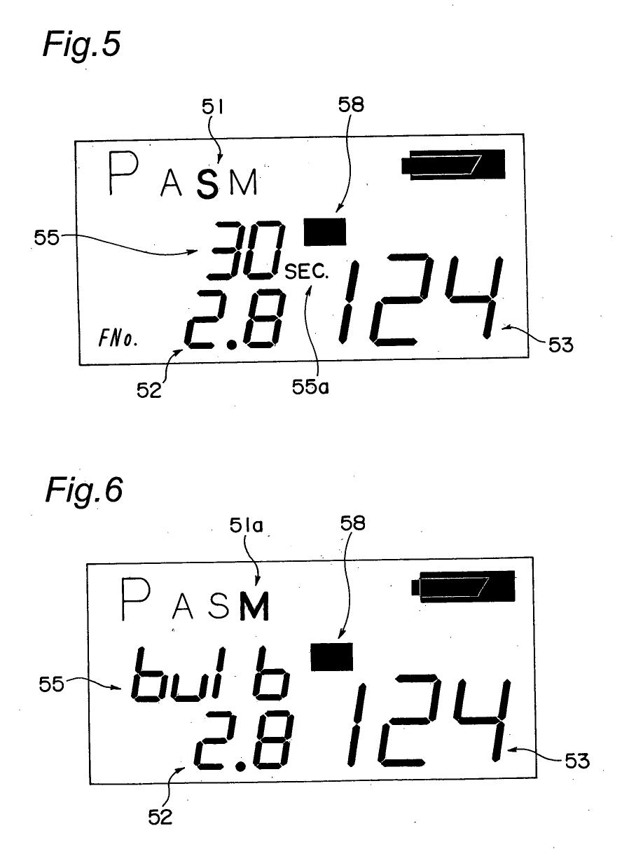

### Shutter-Speed-Priority-Mode (FIGS. 4 and 5)

FIGS. 4 and 5 show a displaying on the LCD 12a at the S-mode. An indication area 51 of “S” turned in black indicates that the S-mode is selected. Further, an indication area 52 of “2.8” represents a f-number, and an indication area 53 of “124” represents the number of frames, which are available for further photographing. Note that, in the S-mode, the f-number is automatically determined, based on the photometry result and the shutter speed which the user set.

In FIG. 4, an indication area 55 of “125” represents that the shutter speed is 1/125 seconds. On the other hand, in FIG. 5, the indication area 55 of “30” represents that the shutter speed is 30 seconds (not 1/30 seconds). In FIG. 5, in order to clarify that the shutter speed is 30 seconds rather than 1/30 seconds, the character “sec.” is also indicated adjacent to the indication “30”.

In this embodiment, the displaying-at-long-time-exposure is to be conducted when the shutter speed (exposure time) which the user set in S-mode is equal to or longer than 4 seconds. Accordingly, in FIG. 5 where the shutter speed is 30 seconds, in order to show that the displaying-at-long-time-exposure is being conducted, an indication area 58 indicates a black square.

Note that the threshold length of the exposure time, which would cause to conduct the displaying-at-long-time-exposure, can be conveniently set.

### Manual-Mode (FIG. 6)

FIG. 6 shows a displaying on the LCD 12a at the M-mode. An indication area 51a of “M” turned in black indicates that the M-mode is selected.

Also in M-mode, when the shutter speed which the user set is equal to or longer than 4 seconds, the displaying-at-long-time-exposure is to be conducted. Particularly, the shutter speed is set equal to or longer than 30 seconds, a B-mode (bulb-exposure mode) is to be conducted, wherein the displaying-at-long-time-exposure is also conducted. FIG. 6 shows the displaying on the LCD 12a at the B-mode, and the characters “bulb” are shown in the indication area 55. As to the f-number in the indication area 52, the value which the user conveniently set is shown.

Also in FIG. 6, like in FIG. 5, the indication area 58 indicates a black square to show that the displaying-at-long-time-exposure is being conducted.

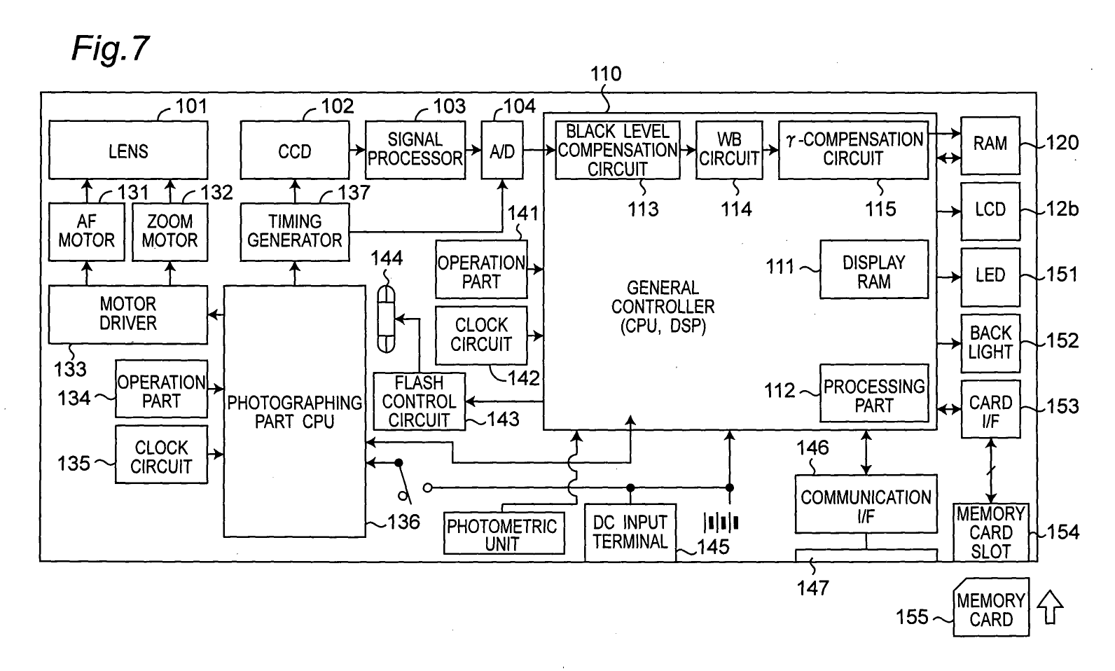

### Block Diagram (FIG. 7)

The internal construction of the camera 10 is explained below, with reference to the block diagram shown in FIG. 7.

Passing through the lens 101, an image of an object is formed on a light receiving surface of the CCD 102. The image signal (analog signal) output from the CCD 102 is subjected to processing such as noise reduction and level adjustment at the signal processor 103, and then is converted into 12 bit digital signal at the A/D (analog-to-digital) conversion circuit 104.

The A/D converted image signal is subjected to a predetermined compensation process at the general processor 110, and then is stored in the RAM 120. This image signal is also transferred to the display RAM 111 in the general processor 110 to display on the LCD 12b.

The black level compensation circuit 113 in the general processor 110 is a circuit that compensates the black level of the A/D converted image signal (pixel data) to a reference value. The WB circuit (white balance circuit) 114 is a circuit that conducts a level conversion of the pixel data comprising the color components of “R” (red), “G” (green), and “B” (blue), such that the white balance is to be adjusted after the black level compensation. The γ-compensation circuit 115 is a circuit that compensates the γ-characteristic of the pixel data.

The AF motor 131 is a motor that drives a focusing lens, based on the control signal from the photographing part CPU 136. Each of the zoom motor 132 and the AF motor 131 is a stepping motor, which is controlled by the motor driver 133, based on the driving pulse from the photographing part CPU 136. The operation part 134 corresponds to the variety of switch members provided on the camera body, such as the release button 16.

The clock circuit 135 generates the clock signals, which are to be transferred to the timing generator 137. The timing generator 137 generates the variety of timing pulse intended for controlling the driving of the CCD 102, and which sends the clock signal to the A/D conversion circuit 104.

Based on the control signal from the general processor 110, the flash control circuit 143 determines whether the built-in flash 144 is operated or not. Then, the flash control circuit 143 also controls the amount of flashing, and the timing of flashing. The operation part 141 corresponds to the variety of switch members provided on the camera body, such as the dials 14, 15, the cross key 19, and so on. The clock circuit 142 generates the clock signals, which are to be transferred to the general processor 110.

The connecting terminal 147 are provided on the camera body, to which a computer and so on are connected. The computer connected thereto communicates with the general processor 110 via the communication I/F 146. On the camera body, the DC input terminal 145 is also provided.

LED 151 is provided on the camera body, and which corresponds to an LED lighting up when the main switch is turned on, or an LED indicating that the general processor 110 is accessing the memory card. The back light 152 illuminates the LCD 12b from behind to enhance the visibility of the LCD 12b.

The card I/F 153 is an interface via which the general processor 110 writes the image data into the memory card 155, or reading the same from the memory card 155. The memory card 155 is to be inserted into the memory card slot.

In the case that the displaying-at-long-time-exposure is conducted:

i) after the release button is full-pressed, and before the long-time-exposure starts, a pre-photographing is conducted, and the obtained image data (pre-taken image) is stored in the RAM 120;

ii) after the long-time-exposure starts, and during the image signal after photoelectric transfer at the CCD 102 is being accumulated, the pre-taken image stored in the RAM 120 is transferred to the general processor 110, and the pre-taken image is processed at the processing part 112, such that the pre-taken image has the brightness level according to the time period within which the exposure has been done;

iii) the image signal after the processing is transferred to the display RAM 111 in the general processor 110 to display on the LCD 12b.

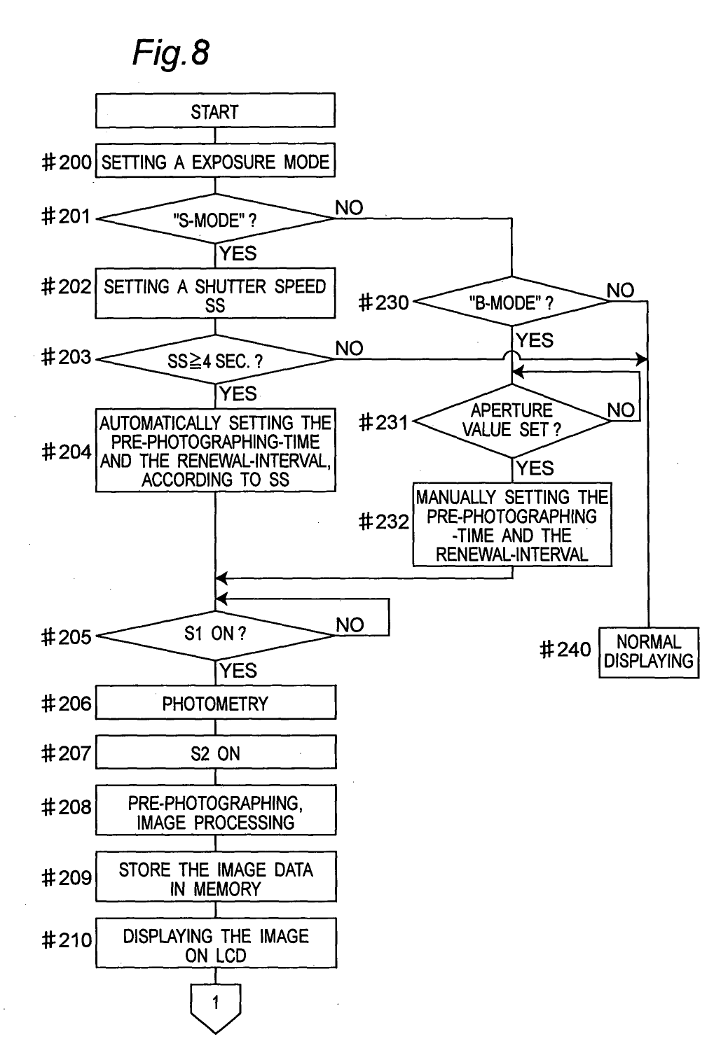

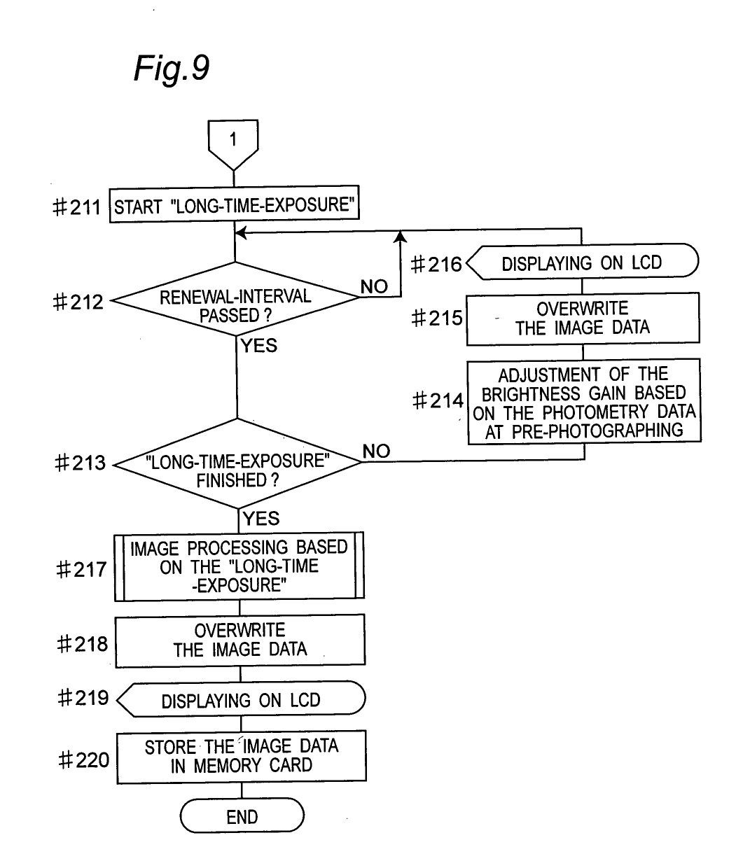

### Flowchart (FIGS. 8 and 9)

The procedures for conducting the displaying-at-long-time-exposure in the camera shown in FIGS. 1 and 2 are explained below, with reference to the flowchart in FIGS. 8 and 9.

One exposure mode is set according to user's selection (#200), and it is judged whether the selected exposure mode is S-mode or B-mode (judgement section). The exposure mode is not S-mode or B-mode, the displaying on the LCD is conducted in a normal displaying mode rather than the displaying-at-long-time-exposure (#201→#230→#240).

If the exposure mode is S-mode, a shutter speed is set according to the user's selection (#202), and it is judged whether the shutter speed is equal to or larger than 4 seconds, or not (#203). If the shutter speed is less than 4 seconds, the flow proceeds to #240, where the normal displaying mode is conducted.

If the shutter speed is equal to or larger than 4 seconds, the conditions (“pre-photographing time” and “renewal-interval”) at the displaying-at-long-time-exposure are set, according to the shutter speed which the user set (#204; setting section). This setting is automatically established for a shutter speed, according to a predetermined table, as explained below. Note that when the pre-photographing is conducted, the aperture is full open.

On the other hand, when the exposure mode is judged to be the B-mode, the “aperture value for main-photographing”, “pre-photographing time”, and “renewal-interval” are set, according to the user's selection (#231→#232).

Note that the “pre-photographing time” means the time period during which the exposure is being conducted at the pre-photographing. Further, the “renewal-interval” means the time period (or time span) during which one image is being displayed when a plurality of predicted images are renewed in order from the pre-taken image.

As one can see from the above explanations, when the displaying-at-long-time-exposure is conducted in the S-mode, the pre-photographing time and the renewal-interval are automatically set. On the other hand, when the displaying-at-long-time-exposure is conducted in the B-mode, they are conveniently set by the user. This is because, at the B-mode, the user should be able to conveniently set the pre-photographing time and the renewal-interval according to the main-photographing time they intend, so that the pre-taken image is made suitable (not too dark, and not too bright). If this merit can be overlooked, the pre-photographing time and the renewal-interval can be automatically set, also in the B-mode. Then, the flow proceeds to #205 and further.

Waiting for the switch S1 is turned on, and then the photometry starts (#205→#206). If the S-mode is selected, the aperture value for main-photographing is set, based on the result of the photometry. When the release button is full-pressed (#207; this is a photographing instruction from the instructing member), the pre-photographing is conducted (#208), and the obtained image (pre-taken image) is stored in the RAM 120 (#209). During the pre-photographing, the CCD 102 is subjected to exposure for the pre-photographing time, which was set in the step of #204 or #232. Note that the pre-taken image is stored in the RAM 120, after being subjected to the predetermined processing such as the noise reduction and the level adjustment. Further, the processed pre-taken image is also transferred to the display RAM 111 in the general processor 110 to display on the LCD 12b (#210). In the present invention, the steps of #208 to #210 constitute a pre-photographing section. Thereafter, the main-photographing is to be conducted (main-photographing section), according to the exposure mode which was judged at the step of #201 or #230.

During the main-photographing, the pre-taken image displayed on the LCD 12b is subjected to a predetermined processing, which is conducted in the processing part 112 in the general processor 110. The image after the processing (predicted image) is subjected to renewals, according to the condition (renewal-interval) about the displaying-at-long-time-exposure which was set in the step of #204 or #232. The image data after each of the renewals are to be displayed in order (display-renewal section), which is as follows specifically.

After the long-time-exposure starts, waiting for the time corresponding to the renewal-interval, which was set, has been passed (#211→#212). In the case that the long-time-exposure has not been finished when the corresponding time has been passed, some adjustment is conducted (for example, raising up the brightness-gain by one step), based on the photometry data (brightness-level) (#213→#214). After the adjustment, the image data stored in the display RAM 111 is overwrote (#215), and this is to be displayed on the LCD 12b (#216). The above procedures are repeated until the long-time-exposure is finished. When the long-time-exposure is finished, the obtained image data is subjected to predetermined processing, and the image stored in the display RAM 111 is overwrote. Thus renewed image is displayed on the LCD 12b, and this image data is stored in the memory card 155 (#213→#217→#218→#219→#220)

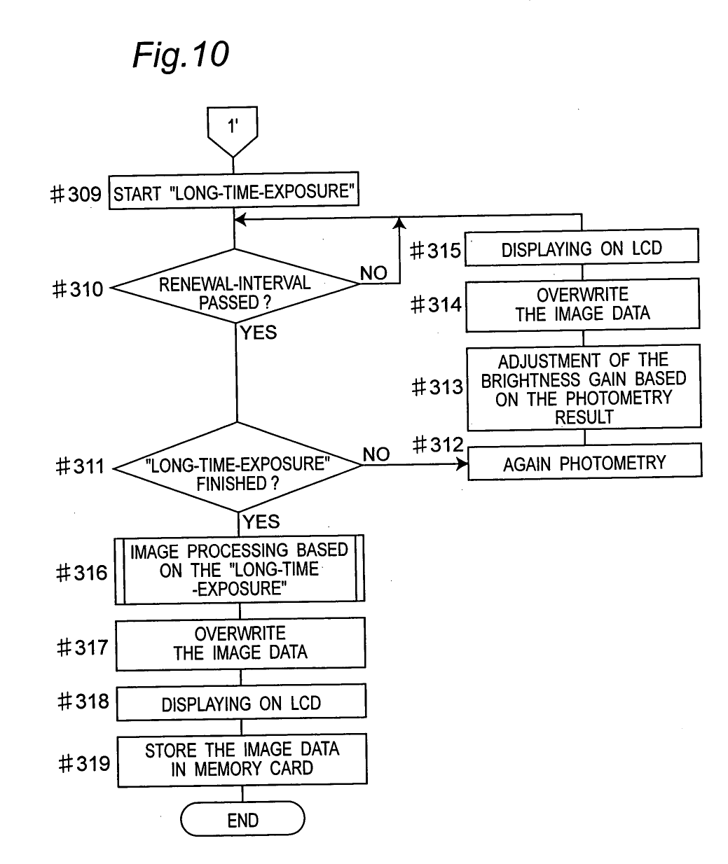

### Flowchart in Another Embodiment (FIG. 10)

FIG. 10 shows a flowchart in an another embodiment. In the previous embodiment in FIGS. 8 and 9, the display-renewal section considers only the photometry data at the time when the pre-photographing was conducted, and the displaying-at-long-time-exposure is conducted with a supposition that the condition does not change after the pre-photographing. Contrary, in this embodiment in FIG. 10, the display-renewal section continues to conduct the photometry still after the pre-photographing, and the displaying-at-long-time-exposure is conducted with a consideration of brightness change after the pre-photographing. Thus, the prediction is preferably improved. For example, even if the strength of the sunlight is suddenly changed after the long-time-exposure starts, the sudden change can be taken into account, so that a predicted image with high precision is displayed.

In this embodiment, the steps of #200 to #210 shown in FIG. 8 are also conducted, and from the step #210 the flow proceeds to the step #309 shown in FIG. 10.

After the long-time-exposure starts, the flow waits until the time corresponding to the renewal-interval has been passed (#309→#310). If the long-time-exposure is not finished when the time corresponding to the renewal-interval has been passed, again the photometry is conducted (#311→#312), and the gain of brightness is adjusted based on the result of the photometry (brightness level) (#313). Then, the image data stored in the display RAM 111 is overwrote into one after the adjustment (#314), and this image data is displayed on the LCD 12b (#315). These procedures are repeated until the long-time-exposure is finished. When the long-time-exposure is finished, the result image data is subjected to a predetermined image processing, and the predicted image stored in the display RAM 111 is overwrote, and it is displayed on the LCD 12b. The overwrote image data is stored in the memory card 155 (#311→#316→#317→#318→#309).

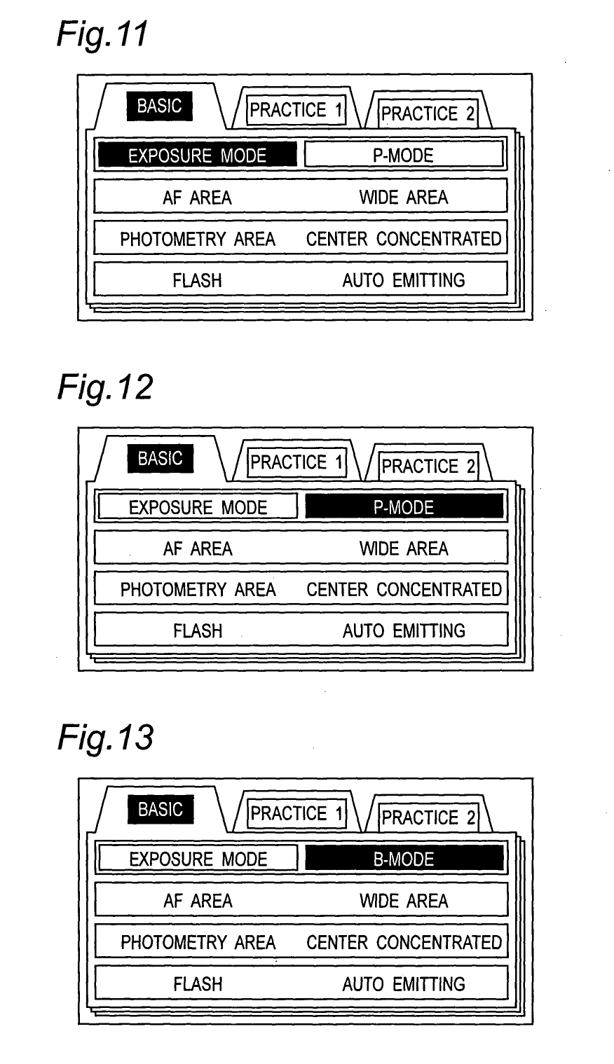

### Setting Manner in each Photographing Mode (FIGS. 11 to 16)

Hereinafter, the setting manner in each photographing mode is explained with reference to FIGS. 11 to 16.

When the camera is in the photographing-mode, pushing the menu button 20 causes a setting window to be displayed on the LCD 12b, which is for setting photographing requirements. FIGS. 11 to 16 show the setting windows. Users can change the requirement items and set the requirement, while watching the setting window and manipulating the dial 14 and the cross key 19.

FIG. 11 shows the initial displaying in the setting window, wherein three sheets are displayed, that is “basic”, “practice 1”, and “practice 2”. User can select one sheet of them with manipulating the cross key 19. In the initial displaying, the cursor is located on the “exposure-mode” in the “basic” sheet.

From this location, manipulating the cross key 19 to move the cursor rightward, the cursor is located on the “P-mode” (program mode) (FIG. 12). Further, manipulating the cross key 19 to move the cursor up and down, the cursor is located on each of the exposure mode in order, that is “P-mode” (program mode), “S-mode” (shutter-speed-priority mode), “A-mode” (aperture-priority mode), “M-mode” (manual mode), and “B-mode” (bulb-exposure mode). Alternatively, each mode can be displayed in a list.

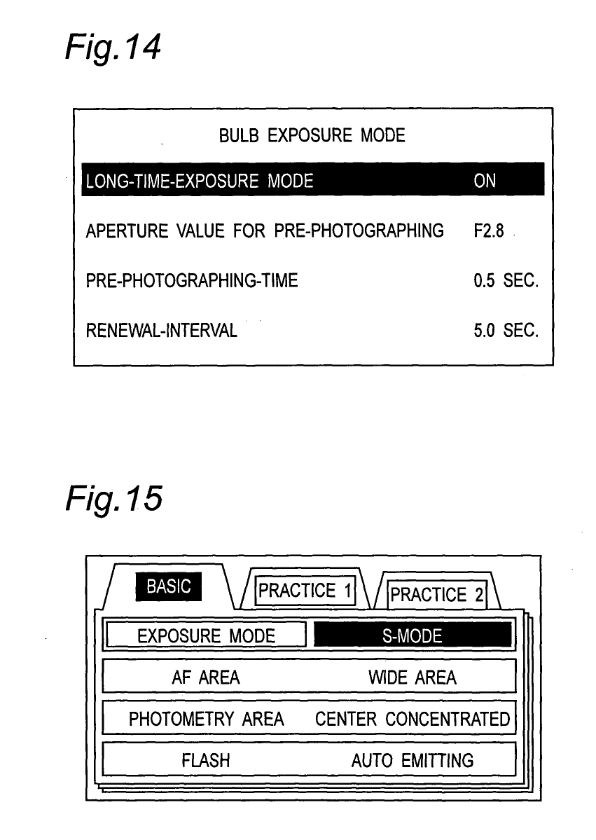

The determination button 19a is pressed when a desired mode is being displayed, and then the selection of the mode is settled. For example, the determination button 19a is pressed when the B-mode is being displayed (FIG. 13), and then the selection of the B-mode is settled, and thereafter a window is displayed (not shown), which is for inputting an aperture value for the main-photographing. After the user input the aperture value, a window is displayed (FIG. 14), which is for setting detailed matters. Here, user inputs the pre-photographing time and the renewal-interval. As to the aperture value for the pre-photographing, the open aperture is employed.

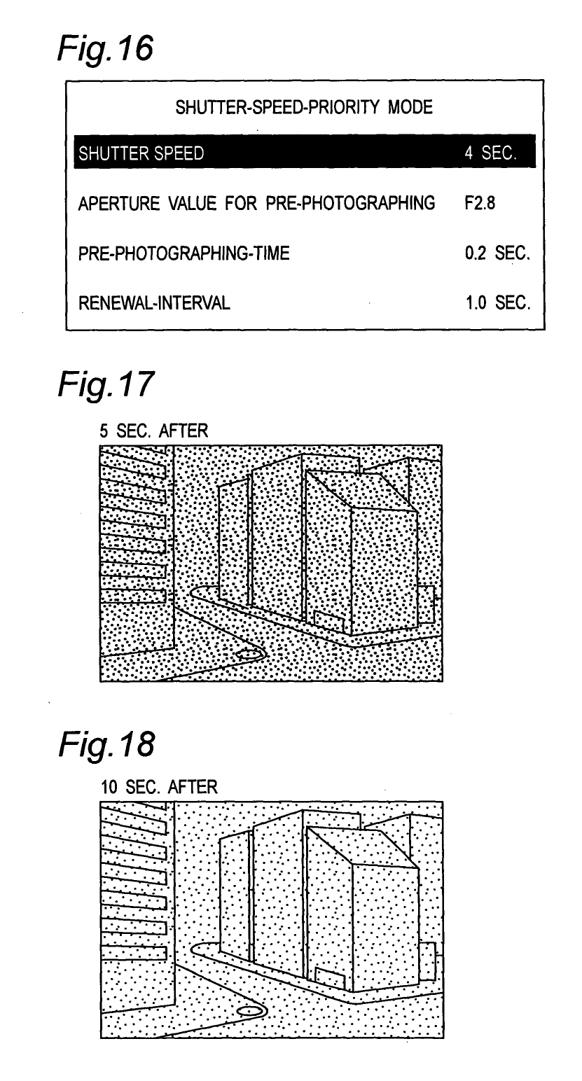

On the other hand, the determination button 19a is pressed when the S-mode is being displayed (FIG. 15), and then the selection of the S-mode is settled, and thereafter a window is displayed (FIG. 16), which is for setting detailed matters. Here, user inputs the shutter speed for pre-photographing. Based on this, the pre-photographing time and the renewal-interval are automatically set. As to the aperture value for the pre-photographing, the open aperture is employed.

That is, in the S-mode, for each shutter speed which the user will set, pre-photographing time (time period for the pre-photographing), and the renewal-interval (time interval for image renewal on the display) are predetermined in a table and stored. Thanks to this, when the user set an exposure time equal to or more than a predetermined length, the pre-photographing time and the renewal-interval can be automatically set, according to the established exposure time. An example of the table is shown below (TABLE 1). In FIG. 16, the established values are displayed.

As explained above, in the B-mode or the S-mode, when a shutter speed (exposure time) is equal to or more than a predetermined value (for example, 4 seconds), the displaying-at-long-time-exposure is to be conducted. Thanks to this, when an exposure time is long and the benefit of the present invention is remarkable, the displaying-at-long-time-exposure is automatically conducted.

TABLE 1

| | shutter speed | | |
|---|---|---|---|
| | 4 sec. | 15 sec. | 60 sec. |
| p.p.t. | 0.2 sec. | 1 sec. | 2 sec. |
| r.i. | 1 sec. | 3 sec. | 5 sec. |

p.p.t.: pre-photographing time
r.i.: renewal-interval

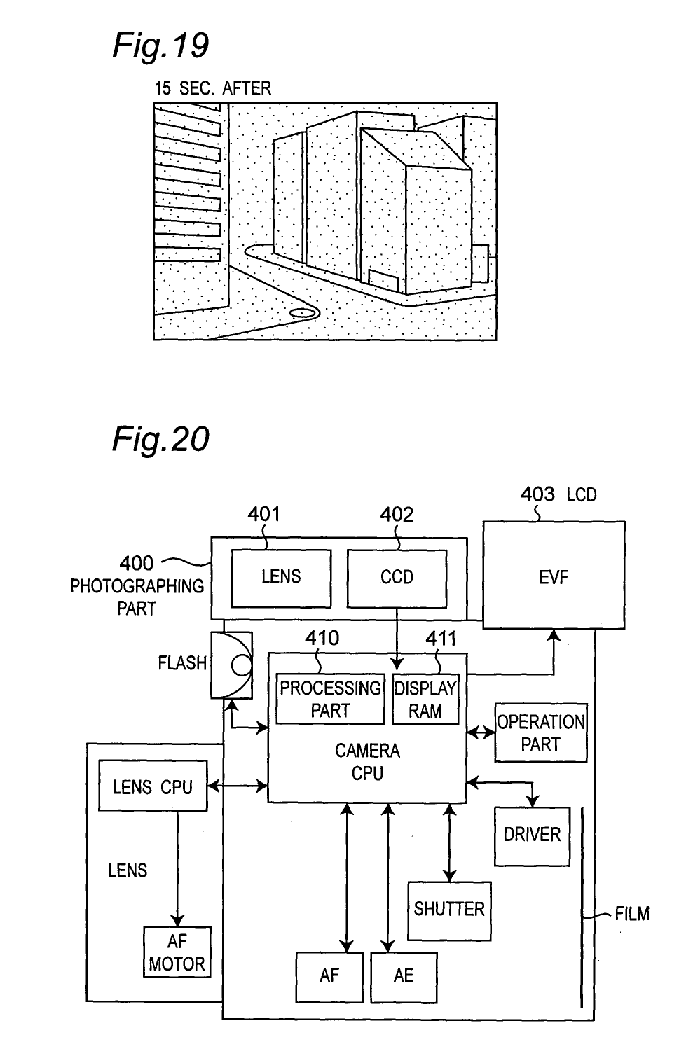

FIGS. 17 to 19 show the predicted images, when 5 seconds have been passed, 10 seconds have been passed, and 15 seconds have been passed, for the 5 seconds of renewal-interval in the camera shown in the drawing. In the present invention, the starting point of the time account is the time, at which the release button is full-pressed. From this starting point, the predicted image on the display is to be renewed, when 5 seconds have been passed, 10 seconds have been passed, and 15 seconds have been passed. Thanks to this, the user can recognize the predicted image on almost real time, when conducting the long-time-exposure photographing. That is, the predicted images are more accurate and the progress of the long-time-exposure can be recognized. Particularly in the B-mode, an effective criterion can be provided, with which the user can judge whether he continues the bulb photographing, or stops it.

### Block Diagram for a Silver Halide Camera (FIG. 20)

The present invention can be applied to not only a digital camera, but also to a silver halide camera. FIG. 20 shows a block diagram in such the embodiment. Images for conducting the displaying-at-long-time-exposure are taken by the photographing part 400, which is separately provided from the photographing optical system. The image taken into the CCD 402 through the lens 401 is subjected to image processing by the processing part 410 in the camera CPU. Thereafter, the image data is transferred to the display RAM 411, and it is displayed on the EVF (LCD) 403. The procedures for conducting the displaying-at-long-time-exposure are the same as those in a digital camera, which were explained above with reference to FIGS. 8 to 10.

Next, the way of image renewal at the displaying-at-long-time-exposure is explained below, with respect to the S-mode and the B-mode.

### The Way of Image Renewal (in S-Mode)

Before the pre-photographing, photometry is conducted to measure the brightness “A” around there. For the measured photometry value and the shutter speed (exposure time “T”) the user set, a proper aperture value “F” is calculated by an APEX calculation. In the shown embodiment, an open aperture is set. That is, the light from an object passes through the lens (with the aperture value of “F”), projects on a film surface or a light receiving surface, and is accumulated during “T” seconds; and then the photographed image can have a proper amount of exposure.

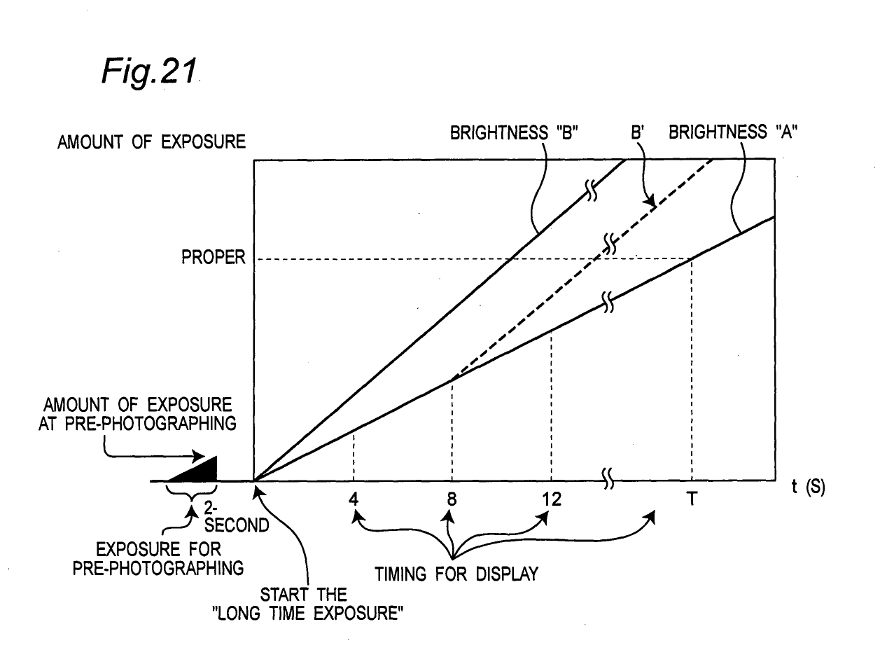

FIG. 21 shows a graph representing the relationship between the exposure time and the amount of exposure, wherein the shutter speed is “T” seconds, the exposure time for pre-photographing is 2 seconds, and the renewal-interval of the image is 4 seconds. The slop of the graph depends on the brightness as a parameter. Under the brightness “B” (more bright than “A”), the slop is more steep, and the proper amount of exposure can be obtained in shorter time than that of the brightness “A”.

The pre-photographing is conducted before the main-photographing. Since the exposure is conducted for 2 seconds in pre-photographing, the light amount received is only 2/T times as that of the proper amount of exposure. After this image data is stored and displayed, the main-photographing starts.

When 4 seconds have been passed after the main-photographing starts, an image data is prepared, wherein the gain is made twice (=4-seconds/2-seconds) that of the pre-taken image taken in the pre-photographing, and this image is displayed on the LCD 12b. When 8 seconds have been passed after the main-photographing starts, another image data is prepared, wherein the gain is made twice as that of the previous image data (=8-seconds/4-seconds; compared with the 1st image data, it can be understood as 4 times), and this image is displayed on the LCD 12b. When 12 seconds have been passed after the main-photographing starts, still another image data is prepared, wherein the gain is made 1.5 times as that of the previous image data (=12-seconds/8-seconds; compared with the 1st image data, it can be understood as 6 times), and this image is displayed on the LCD 12b. The same renewal procedures are repeated, and the exposure is finished when “T” seconds have been passed.

Note that, in the embodiment (the flowchart in FIG. 10), wherein the photometry is continued still after the pre-photographing, and the brightness change thereafter is taken account into the displaying-at-long-time-exposure; for example, if the brightness changes into “B” when 8 seconds have been passed, the control thereafter will be conducted along the dashed line “B1”.

### The Way of Image Renewal (in B-Mode)

In the B-mode, the photometry is previously conducted, and the proper exposure time “T” is obtained for the aperture value “F” (“F” is open aperture in this embodiment). From this, the slop of the graph is determined.

Based on the exposure time for the pre-photographing and the renewal-interval, which the user set, the gain for the next image to be displayed is determined. Note that, in the bulb exposure, the user decide when the exposure is stopped. Thus, if the exposure does not stop still after the proper exposure time has been passed, the exposure is continued thereafter and the image is renewed. After the proper exposure time has been passed, the whole displayed image gradually becomes dark and finally deep black.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A photographing apparatus, comprising:
a photographing part,
a display, on which images taken by the photographing part is displayed,
a judgement section, which judges a photographing mode selected by a user,
a setting section, which sets conditions at displaying-at-long-time-exposure, when the photographing mode judged by the judgement section conducts long-time-exposure photographing,
an instruction member, which instructs the photographing apparatus to start photographing,
a pre-photographing section, which conducts pre-photographing to take a pre-taken image according to an instruction from the instruction member, and which displays the pre-taken image on the display,
a main-photographing section, which conducts main-photographing under the photographing mode judged by the judgement section, after the pre-photographing, and
a display-renewal section, which subjects the pre-taken image to a predetermined processing at a predetermined time interval, and which renews the pre-taken image on the display, during the main-photographing, based on the conditions at the displaying-at-long-time-exposure set by the setting section.

2. The photographing apparatus in claim 1, wherein the photographing mode judged by the judgement section is shutter-speed-priority mode.

3. The photographing apparatus in claim 1, wherein the setting section sets the conditions at the displaying-at-long-time-exposure according to setting by the user, if the photographing mode judged by the judgement section is bulb-exposure mode.

4. The photographing apparatus in claim 1, wherein the display-renewal section renews the pre-taken image, based on an amount of exposure which corresponds to passage of time after the main-photographing starts.

5. The photographing apparatus in claim 1 further comprising a photometric unit, which conducts photometry still after starting the main-photographing, wherein
the display-renewal section renews the pre-taken image based on a result of the photometry after starting the main-photographing.

6. The photographing apparatus in claim 1 further comprising a photometric unit, wherein
the display-renewal section renews the pre-taken image based on a result of the photometry at the pre-photographing with a supposition that the result of the photometry does not change after the pre-photographing.

7. The photographing apparatus in claim 1, wherein the setting section automatically sets an exposure time for the pre-photographing corresponding to a shutter speed which the user set, if the photographing mode judged by the judgement section is shutter-speed-priority mode.

8. The photographing apparatus in claim 1, wherein the setting section automatically sets a renewal-interval for the displaying-at-long-time-exposure corresponding to a shutter speed which the user set, if the photographing mode judged by the judgement section is shutter-speed-priority mode.

9. A method for displaying predicted images on a display during long-time-exposure photographing, comprising steps of:
judging a photographing mode selected by a user,
setting conditions at displaying-at-long-time-exposure, when the photographing mode, which was judged, conducts the long-time-exposure photographing,
conducting pre-photographing to take a pre-taken image according to an instruction from an instruction member,
displaying the pre-taken image on the display,
conducting main-photographing under the photographing mode which was judged, after the pre-photographing,
processing the pre-taken image in a predetermined manner, and
renewing the pre-taken image on the display, during the main-photographing, based on the conditions at the displaying-at-long-time-exposure which was set.

10. A photographing apparatus, comprising:
a photographing part, which conducts pre-photographing and main-photographing, and
a display, on which a pre-taken image obtained by the pre-photographing is displayed, and the pre-taken image is renewed after being processed in a predetermined manner during the main-photographing.

11. The photographing apparatus in claim 10 further comprising a judgement section, which judges a photographing mode selected by a user, wherein
the pre-photographing and the main-photographing are conducted only when shutter-speed-priority mode or bulb-exposure mode is judged by the judgement section.

12. The photographing apparatus in claim 11 further comprising a setting section, which sets displaying conditions on the display.

13. The photographing apparatus in claim 12, wherein the setting section automatically sets an exposure time for the pre-photographing corresponding to a shutter speed which a user set, if the photographing mode judged by the judgement section is shutter-speed-priority mode.

14. The photographing apparatus in claim 12, wherein the setting section automatically sets a renewal-interval corresponding to a shutter speed which a user set, if the photographing mode judged by the judgement section is shutter-speed-priority mode.

15. The photographing apparatus in claim 12, wherein the setting section sets displaying conditions according to setting by a user, if the photographing mode judged by the judgement section is bulb-exposure mode.

16. The photographing apparatus in claim 10, wherein the pre-taken image on the display is subjected to a predetermined processing at a predetermined time interval, for renewal.

17. The photographing apparatus in claim 16, the renewal is conducted, based on an amount of exposure which corresponds to passage of time after the main-photographing starts.

18. The photographing apparatus in claim 16 further comprising a judgement section, which judges a photographing mode selected by a user, and a setting section, which sets displaying conditions on the display, wherein
the setting section sets a renewal-interval corresponding to a shutter speed which a user set, if the photographing mode judged by the judgement section is shutter-speed-priority mode.

19. The photographing apparatus in claim 10 further comprising a photometric unit, which conducts photometry still after starting the main-photographing, wherein
the pre-taken image on the display is renewed based on a result of the photometry after starting the main-photographing.

20. The photographing apparatus in claim 10 further comprising a photometric unit, wherein
the pre-taken image on the display is renewed based on a result of the photometry at the pre-photographing with a supposition that the result of the photometry does not change after the pre-photographing.
